(19) United States
(12) Patent Application Publication
(10) Pub. No.: US 2024/0381261 A1
(43) Pub. Date: Nov. 14, 2024

(54) LOW-POWER WAKE-UP RADIO AND MAIN RADIO ON AND OFF MECHANISM

(71) Applicant: APPLE INC., Cupertino, CA (US)

(72) Inventors: Fangli Xu, Beijing (CN); Sigen Ye, San Diego, CA (US); Dan Wu, Beijing (CN); Dawei Zhang, Saratoga, CA (US); Haijing Hu, Los Gatos, CA (US)

(21) Appl. No.: 18/658,182

(22) Filed: May 8, 2024

Related U.S. Application Data
(60) Provisional application No. 63/501,554, filed on May 11, 2023.

(51) Int. Cl. H04W 52/02

(52) U.S. Cl. CPC H04W 52/0235; H04W 52/0216

(57) ABSTRACT

A user equipment (UE) may include a main radio (MR) and a Low Power Wake-Up Radio (LR). The UE may coordinate periods where the MR and LR are on and off. For example, the UE may enter a deep sleep state by turning off a main radio (MR) of the UE, and turning on a Low Power Wake-Up Radio (LR) of the UE. The MR may receive an event indication from the LR to turn on the MR. The MR may turn on and perform a procedure according to an event corresponding to the event indication.

### TECHNICAL FIELD

This application relates generally to wireless communication systems, including the coordination of a low-power wake-up radio and a main radio in a user equipment apparatus.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a UE comprising LR and MR modules in accordance with some embodiments.

FIG. 1B illustrates two states of the UE in accordance with some embodiments.

FIG. 2 illustrates a simplified signal flow diagram for turning the LR to an ON state in accordance with some embodiments

FIG. 3 illustrates a simplified signal flow diagram for entering deep sleep state (i.e., turning the MR to an OFF state) in accordance with some embodiments.

FIG. 4 illustrates a signal flow diagram for leaving deep sleep state (i.e., turning the MR to an ON state) based on the LR sending a trigger to the MR in accordance with some embodiments

FIG. 5 illustrates a simplified signal flow diagram for leaving deep sleep state (i.e., turning the MR on) based on an LP-WUS from a network node while the UE is in an RRC_IDLE/INACTIVE state in accordance with some embodiments.

FIG. 6 illustrates a simplified signal flow diagram for leaving deep sleep state (i.e., turning the MR on) based on an LP-WUS from a network node while the UE is in a CONNECTED state in accordance with some embodiments.

FIG. 7 illustrates a simplified signal flow diagram for leaving deep sleep state (i.e., turning the MR on) based on the LR detecting a current serving cell's radio quality is worse than a threshold in accordance with some embodiments.

FIG. 8 illustrates a simplified signal flow diagram for leaving or entering deep sleep state (i.e., turning the MR on and off) based on the LR detecting a current serving cell's radio quality in accordance with some embodiments

FIG. 9 illustrates a simplified signal flow diagram for leaving deep sleep state (i.e., turning the MR on) based on the LR determining that a NAS periodical registration timer has expired in accordance with some embodiments.

FIG. 10 illustrates a simplified signal flow diagram for leaving deep sleep state (i.e., turning the MR on) based on the LR determining that an AS RNAU timer has expired in accordance with some embodiments.

FIG. 11 illustrates a simplified signal flow diagram for leaving deep sleep state (i.e., turning the MR on) based on the LR determining that DRX on duration timer has expired in accordance with some embodiments.

FIG. 12 illustrates a simplified signal flow diagram for leaving deep sleep state (i.e., turning the MR on) based on a status of the LR in accordance with some embodiments.

FIG. 13 illustrates a simplified signal flow diagram for leaving deep sleep state (i.e., turning the MR on) based on an internal trigger in the MR in accordance with some embodiments.

FIG. 14 illustrates a simplified signal flow diagram of leaving deep sleep state (i.e., an MR turning on) based on an external trigger from LR when the UE is in an IDLE/INACTIVE state in accordance with some embodiments.

FIG. 15 illustrates a simplified signal flow diagram of leaving deep sleep state (i.e., an MR turning on) based on an external trigger from LR when the UE is in a CONNECTED state in accordance with some embodiments.

FIG. 16 illustrates a simplified signal flow diagram for entering deep sleep state (i.e., turning the MR off) based on data activity in accordance with some embodiments.

FIG. 17 illustrates a simplified signal flow diagram for entering deep sleep state (i.e., turning the MR off) based on a command from the network node in accordance with some embodiments.

FIG. 18 illustrates a simplified signal flow diagram for entering deep sleep state (i.e., turning the MR off) based on the UE RRC state transition in accordance with some embodiments.

FIG. 19 illustrates a simplified signal flow diagram for entering deep sleep state (i.e., turning the MR off) based on DRX OFF state in accordance with some embodiments.

FIG. 20 illustrates a simplified signal flow diagram where the LP-WUS function is enabled/activated based on an indication/configuration from network side in accordance with some embodiments.

FIG. 21 illustrates a simplified signal flow diagram where the LP-WUS function is activated/enabled based on RRC state in accordance with some embodiments.

FIG. 22 illustrates a signal flow diagram for leaving deep sleep state (i.e., turning off the LR) based on an indication from the MR in accordance with some embodiments.

FIG. 23 illustrates a signal flow diagram for leaving deep sleep state (i.e., turning off the LR) when the LP-WUS function cannot work well in accordance with some embodiments.

FIG. 24 illustrates a flowchart of a method for a UE, according to embodiments herein.

FIG. 25 illustrates a flowchart of a method for a UE, according to embodiments herein.

FIG. 26 illustrates an example architecture of a wireless communication system, according to embodiments disclosed herein.

FIG. 27 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Two goals of a wireless communication systems is to reduce power consumption and reduce latency. In some embodiments, to reduce UE power consumption, discontinuous reception (DRX) cycle with a large value may be used to enlarge the UE battery life. The large value DRX cycle may be referred to as an extended DRX (eDRX). Extended DRX allows the UE to stay in a low power state for extended periods of time by reducing the frequency at which the UE communicates with the network. An IDLE/INACTIVE UE is only required to wake up once per DRX cycle for paging monitoring, and Radio Resource Management (RRM) measurement.

However, the eDRX mechanism cannot always meet requirements of both long battery life and low latency. The longer the DRX cycle, the more UE power consumption is reduced, but a longer service delay is introduced. The extended periods between two consecutive network connection attempts may introduce latency that is higher than desirable.

Accordingly, it may be desirable to introduce functions that wake up the UE when the UE is paged by the network node. By waking up when paged, UE power consumption could be dramatically reduced while maintaining a low latency. This can be achieved by using a wake-up signal (WUS) to trigger the main radio (MR) and a separate receiver which has the ability to monitor wake-up signal with ultra-low power consumption. The main radio works for data transmission and reception, which can be turned off or set to deep sleep unless it is turned on.

For example, a UE may use a Low Power Wake-Up Radio (LP-WUR) also referred to herein as LR. LP-WUR is a feature that enables a UE in a wireless network to save power by remaining in a low-power sleep state until a wake-up signal is received. When the wake-up signal is detected, the UE wakes up to establish a connection with the network node using a main radio to transmit or receive data, and then returns to its low-power state.

LP-WUR is particularly useful for IoT (Internet of Things) devices, which may need to transmit small amounts of data sporadically and conserve battery life as much as possible. By using LP-WUR, these devices can remain in a low-power state for extended periods, conserving energy until they need to transmit or receive data.

A number of power saving schemes are supported in 3GPP. In 3GPP release 15, connected mode DRX (C-DRX) for CONNECTED state, and idle mode DRX (I-DRX) for IDLE/INACTIVE state were introduced. In 3GPP release 16, WUS for DRX active time control in CONNECTED state was introduced. A new DCI was introduced to indicate whether the UE needs to wake up per DRX on duration. If the new UE indicates the UE does not need to wake up, the UE will not wake up during the associated DRX on duration period. Additionally, in release 16, RRM measurement relaxation in IDLE/INACTIVE state was introduced. The UE can relax the RRM measurement for IDLE/INACTIVE mobility if the UE is in low mobility state, or the UE is not in the cell edge.

In 3GPP release 17, paging optimization (Permanent Equipment Identifier (PEI) and paging subgrouping) where introduced. PEI is a DCI to inform UE whether there is actual paging transmission in the associated paging occasion (PO). For paging subgrouping, the UE is further divided into paging subgrouping, and paging subgrouping info is carried in the paging scheduling info. In release 17, Radio Link Monitoring (RLM) and beam failure detection (BFD) relaxation in CONNECTED state were introduced. Further, eDRX mechanism was introduced where the DRX cycle is {2.56 sec, 5.12s, 10.24s, 20.48s, . . . , 1024×1024 (2.91 hrs)}.

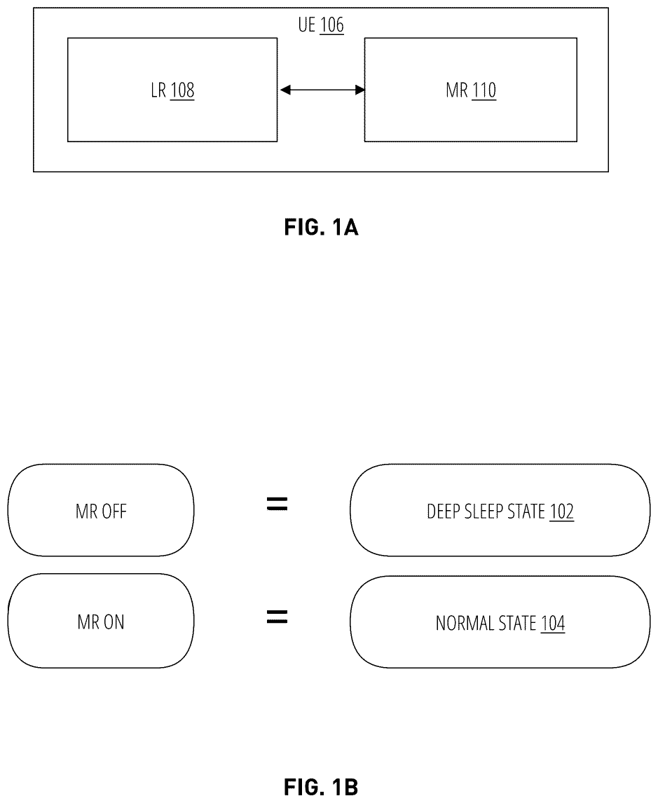

FIG. 1A illustrates a UE 106 comprising LR 108 and MR 110 modules in accordance with some embodiments. The LR 108 enables the UE 106 to save power by remaining in a low-power sleep state until it receives a wake-up signal. When the wake-up signal is detected, the UE 106 may return to a normal state and use the MR to communicate with a network node. A low-power wake-up signal for an LR 108 may be used for power-sensitive, small form-factor devices including IoT use cases (such as industrial sensors, controllers) and wearables, extended reality (XR) devices, smart glasses, and smart phones.

The hardware modules may include the MR 110 and a separate LR 108. The MR 110 may be a transmit and receive module operating for new radio (NR) signals and channels apart from signals and channel related to the low-power wake-up. The LR 108 may be a receive module operating for receiving and processing the signals and channel related to low-power wake-up. The MR 110 and LR 108 may support multiple RRC state. Both RRC IDLE/INACTIVE and CONNECTED modes may be studied as part of the low power (LP) WUS/WUR.

In some embodiments, LP-WUS may be sent from a network node on a Uu interface. A wireless communication system may include a UE, a Radio Access Network (NG-RAN) and the Core Network. The main entity of the NG-RAN may be a network node. The radio interface between the network node and the UE may be referred to as the Uu interface.

FIG. 1B illustrates two states of the UE 106 in accordance with some embodiments. In the illustrated embodiment, when the MR 110 is in the ON state, the UE 106 is considered to be operating in normal state 104. When MR 110 is in the OFF state, the UE 106 is considered to be operating in the deep sleep state 102.

While the use of the LR 108 may reduce power consumption while maintaining a latency requirement, there are several open issues currently regarding the use of LR 108 and MR 110. For example, it has not been clearly identified when to turn on/off the LR 108 and the MR 110. Embodiments herein provide methods, apparatuses, and systems that specify the procedure for turning on and off the LR 108 and MR 110.

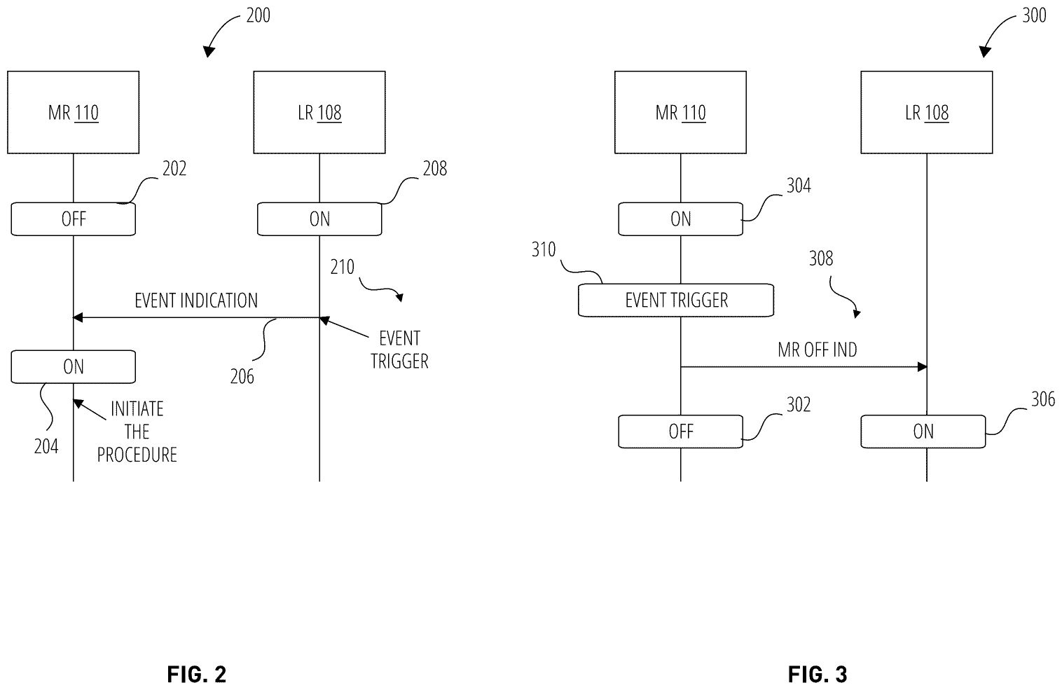

FIG. 2 illustrates a simplified signal flow diagram 200 for turning the LR 108 to an ON state in accordance with some embodiments. The MR ON control may be triggered by one or both of external and internal triggers. In the illustrated embodiment, the LR 108 begins in an OFF state 202, and the LR 108 is in an ON state 208.

For example, some embodiments may use a first ON-Model (herein referred to as ON-Model 1). For embodiments using ON-Model 1, the LR 108 may be turned on only based on an external trigger from the LR 108. Accordingly, in ON-Model 1, the LR 108 may be responsible to determine all the events that should trigger the LR 108 to enter an ON state 204. For example, as shown, the LR 108 may detect an event trigger 210. The event trigger 210 may correspond to an event that, when it occurs, the LR 108 provides an event indication 206 to the LR 108.

For ON-Model 1, there may be several events that may trigger the LR 108 to send the event indication 206. In some embodiments, the events may include when the LR 108 receives an indication from the network side in Uu interface. The indication may be UE's LP-WUS. In some embodiments, the events may include when LR 108 detects current serving cell's radio quality becomes worse. In some embodiments, the events may include when LR 108 detects some timers expiry. Accordingly, the LR 108 may include some timer functions. In some embodiments, the events may include other events which require the LR 108 turn on to work such as a failure or error case. When the LR 108 receives the event indication 206, the LR 108 turns on and initiates a procedure according to the corresponding event (e.g., reception, transmission, measurement, etc.).

Some embodiments may use a second ON-Model (herein referred to as ON-Model 2). For embodiments using ON-Model 2, the LR 108 may be turned on based on an external trigger from LR 108 and an internal trigger from itself. For the external trigger, the LR 108 may determine when certain events occur. For example, the LR 108 may monitor for an indication (e.g., the LP-WUS signal associated with the UE)) from the network, and provide the event indication 206 to the LR 108 when the indication is received. Further, the LR 108 may detect when a current serving cell's radio quality becomes worse and send the event indication 206. In some embodiments, the LR 108 may detect when other events which require the LR 108 turn on to work such as a failure or error case and send the event indication 206. When the LR 108 receives the event indication 206, the LR 108 turns on and initiates a procedure according to the corresponding event (e.g., reception, transmission, measurement, etc.).

For the internal trigger, the LR 108 may not fully turn off when in a deep sleep state. For example, during the deep sleep state, the LR 108 may maintain some periodical cellular timers. When the LR 108 determines that one of the periodical cellular timers has expired, the LR 108 turns on and initiates a procedure according to the corresponding event (e.g., reception, transmission, measurement, etc.). Accordingly. The LR 108 may enter an ON state and determine which procedure to initiate based on both an external trigger and internal situation/trigger.

FIG. 3 illustrates a simplified signal flow diagram 300 for turning the MR 110 to an OFF state in accordance with some embodiments. The MR OFF control may be triggered by the MR itself and/or based on a LR indication. In the illustrated embodiment, the MR 110 begins in an ON state 304. After a 310 occurs, the MR 110 sends the LR 108 an MR OFF indication 308 and enters an OFF state 302. The MR OFF indication 308 may inform the LR 108 that the MR 110 is entering the OFF state 302, and the LR 108 may enter an ON state 306 and begin operation.

Some embodiments may use a first OFF-Model (herein referred to as OFF-Model 1). For embodiments using OFF-Model 1, the LR 108 may control when it turns off. The 310 may be caused by multiple events. In some embodiments, the events may include when the MR 110 detects there is no the activity and predicts there is no activity for some time later. In some embodiments, the events may include when the MR 110 receives NW command to turn. In some embodiments, the events may include when the UE RRC state transition occurs (e.g., entering RRC IDLE/INACTIVE state). When the MR 110 detects one of these events, the MR 110 sends the MR OFF indication 308 and the LR 108 starts to work.

Some embodiments may use a second OFF-Model (herein referred to as OFF-Model 2). For embodiments using OFF-Model 2, the MR 110 may turn off based on an indication from the LR 108. In some embodiments, the MR 110 may turn off based on an external trigger from LR 108 and internal trigger from itself.

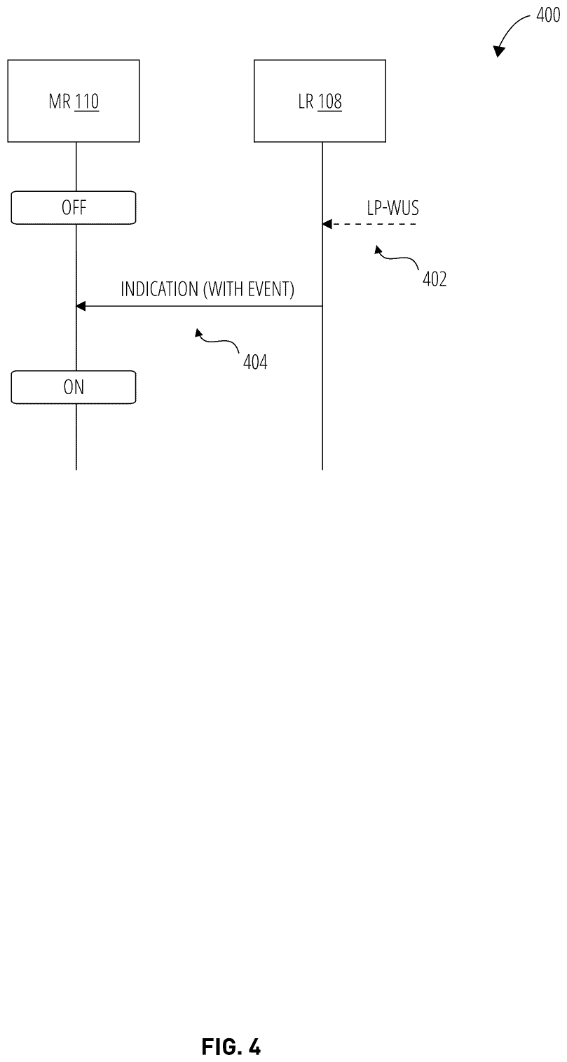

FIG. 4 illustrates a signal flow diagram 400 for turning the MR 110 to an ON state based on the LR 108 sending a trigger (e.g., indication 404) to the MR 110 in accordance with some embodiments. When the MR 110 is OFF, the LR 108 may perform one or more of the following operations. The LR 108 may monitor and detect an LP-WUS 402. The LR 108 may perform measurements based on the LP-WUS 402. The LR 108 may maintain some Access-Stratum/Non-Access-Stratum (AS/NAS) periodic timers.

In some embodiments, when the following events occur, the LR 108 sends the indication 404 to MR 110. A first event may be when the LR 108 receives the UE's WUS. A second event may be when the LR 108 detects that a current serving cell's radio quality is worse than a threshold. A third event may be when the LR 108 detects some timer's expiry.

For the first event, the LR 108 may receive the UE's LP-WUS 402, and send an indication to the MR 110. The MR 110 turns on and starts the operation according to the Radio Resource Control (RRC) state. In RRC_CONNECTED, the UE MR 110 turns on and enters a DRX ON state according to some specific timing, or in the next available ON duration period. In RRC_IDLE/INACTIVE, the UE MR 110 turns on and starts receiving paging/PEI, and performs measurements according to the PO location of the UE.

For the second event, the LR 108 may detect the current serving cell's radio quality is worse than a threshold. In some embodiments, the LR 108 performs the measurement based on the LP-WUS 402 signaling. When the LP-WUS 402 quality is less than the threshold, MR 110 may be turned on for measurement purpose. The threshold may be configured by the network.

For the third event, the LR 108 may maintain the cellular timers and detect the timer's expiry. For periodical cellular timers, the timers are running on the LR 108, and when the timer expires, the LR 108 provides the indication 404 and together with the corresponding event to the MR 110. For example, the LR 108 may maintain the NAS periodical registration timer and when the timer expires and the MR 110 is OFF, the LR 108 indicates the timer expiry event to the MR 110, and the MR 110 will turn on and trigger registration procedure. As another example, when the UE is in an INACTIVE state, the LR 108 may maintain the RAN-based notification area update (RNAU) timer and when the timer expires and the MR 110 is OFF, the LR 108 indicates the RNAU timer expiry to the MR 110, and the MR will turn on and trigger the RNAU procedure. As yet another example, when the UE is in a CONNECTED state, the LR 108 maintains the DRX on duration timer, and when the on duration timer is about to start and MR 110 is OFF, the LR 108 indicates an on duration timer start event to the MR 110, and the MR 110 may turn on and enter a DRX ON state.

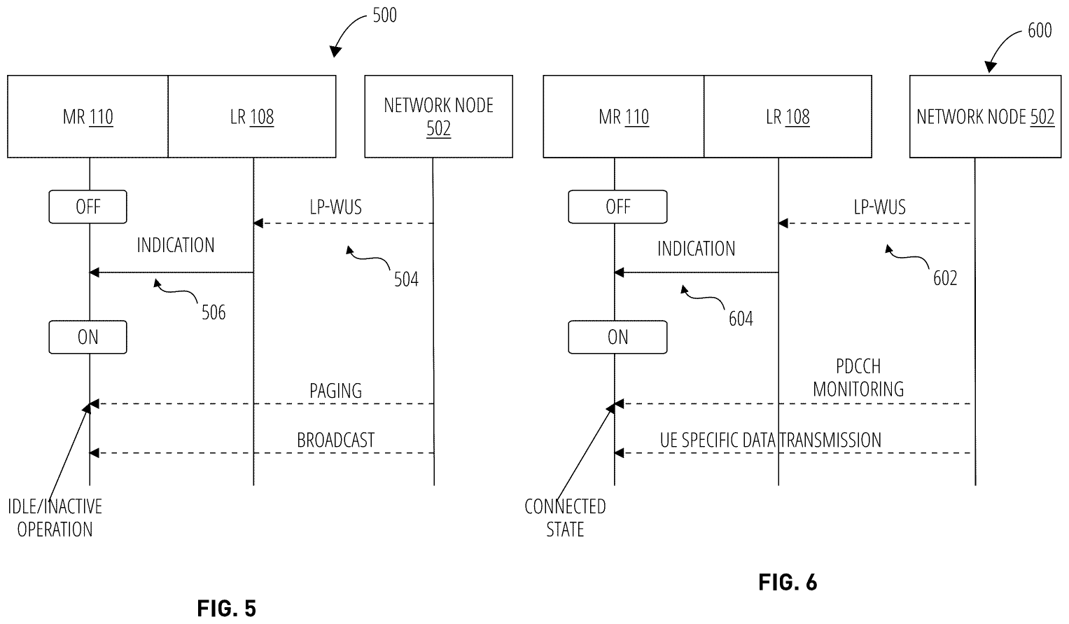

FIGS. 5-12 illustrate more signal flow diagrams of the events described above using ON-Model 1. Any or all of the embodiments described with reference to FIGS. 5-12 may be combined.

FIG. 5 illustrates a simplified signal flow diagram 500 for turning the MR 110 on based on an LP-WUS 504 from a network node 502 while the UE is in an RRC_IDLE/INACTIVE state. As shown, the LR 108 receives the LP-WUS 504 for the UE. The LP-WUS 504 indicates that the UE should wake up. The LR 108 sends an indication 506 to the MR 110. The indication 506 may inform the MR 110 that the LP-WUS 504 was received. The MR 110 turns on and starts the operation according to the RRC state. In RRC_IDLE/INACTIVE state, the MR 110 turns on and starts receiving paging/PEI from the network node 502, and perform measurement according to its PO location. The network node 502 may also send a broadcast signal that the MR 110 may receive.

FIG. 6 illustrates a simplified signal flow diagram 600 for turning the MR 110 on based on an LP-WUS 602 from a network node 502 while the UE is in a CONNECTED state. As shown, the LR 108 receives the LP-WUS 602 for the UE. The LP-WUS 602 indicates that the UE should wake up. The LR 108 sends an indication 604 to the MR 110. The indication 604 may inform the MR 110 that the LP-WUS 602 was received. The MR 110 turns on and starts the operation according to the RRC state. In the CONNECTED state, the MR 110 turns on and enters DRX ON state according to some specific timing, or in the next available on duration period. The MR 110 may begin PDCCH monitoring and receive UE specific data transmission from the network node 502.

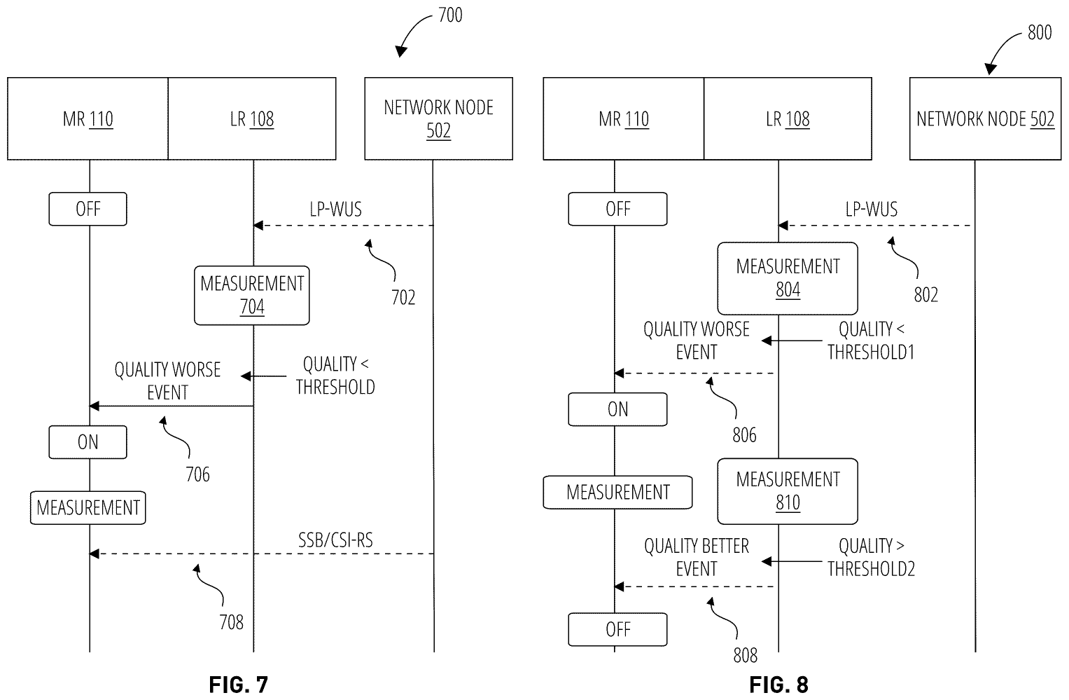

FIG. 7 illustrates a simplified signal flow diagram 700 for turning the MR 110 on based on the LR 108 detecting a current serving cell's radio quality is worse than a threshold in accordance with some embodiments. As shown, the LR 108 may perform a measurement 704 based on the LP-WUS 702 from the network node 502.

The trigger condition for turning on the MR 110 may be based on how the measurement 704 compares to a threshold. The LR 108 may compare the measurement 704 to the threshold. When the LP-WUS 702 quality is less than the threshold, the LR 108 will trigger the MR ON indication 706. The indication 706 may indicate that the LR 108 has detected a low radio quality event.

The threshold may be configured by the network node 502. The configuration of the LP-WUS based measurement and threshold/condition evaluation may be provided by the MR 110 to LR in advance. For example, before the MR 110 turns off, the network node 502 may provide measurement configuration details that the MR 110 may provide to the LR 108.

The MR 110, when receiving the indication 706, may turn on and initiate the RRM measurements on both serving cell and neighbor cell for mobility purpose. In some embodiments, the MR 110 first checks the serving cell quality based on the SSB/CSI-RS 708 measurement, and decides whether to start the measurement on neighbor cell based on the measurement. In some embodiments, the MR 110 directly starts the measurement on neighbor cell.

FIG. 8 illustrates a simplified signal flow diagram 800 for turning the MR 110 on and off based on the LR 108 detecting a current serving cell's radio quality in accordance with some embodiments. As shown, the LR 108 may perform a measurement 804 based on the LP-WUS 802 from the network node 502.

The trigger condition for turning on the MR 110 may be based on how the measurement 804 compares to a threshold. The LR 108 may compare the measurement 804 to the threshold. When the LP-WUS 802 quality is less than the threshold, the LR 108 will trigger the MR ON indication 806. The indication 806 may indicate that the LR 108 has detected a low radio quality event.

The threshold may be configured by the network node 502. The configuration of the LP-WUS based measurement and threshold/condition evaluation may be provided by the MR 110 to LR in advance. For example, before the MR 110 turns off, the network node 502 may provide measurement configuration details that the MR 110 may provide to the LR 108.

The MR 110, when receiving the indication 806, may turn on and initiate the RRM measurements on both serving cell and neighbor cell for mobility purpose. In some embodiments, the MR 110 first checks the serving cell quality based on the SSB/CSI-RS measurement, and decides whether to start the measurement on neighbor cell based on the measurement. In some embodiments, the MR 110 directly starts the measurement on neighbor cell.

Further, in some embodiments, the LR 108 may continue to monitor the LP-WUS 802 (e.g., second measurement 810). When the LR 108 detects the LP-WUS 802 quality is greater than a threshold for some time, the LR 108 may send a second indication 808 to inform MR 110 to cancel the quality event or send an MR OFF indication. The MR 110 may turn off based on the second indication 808.

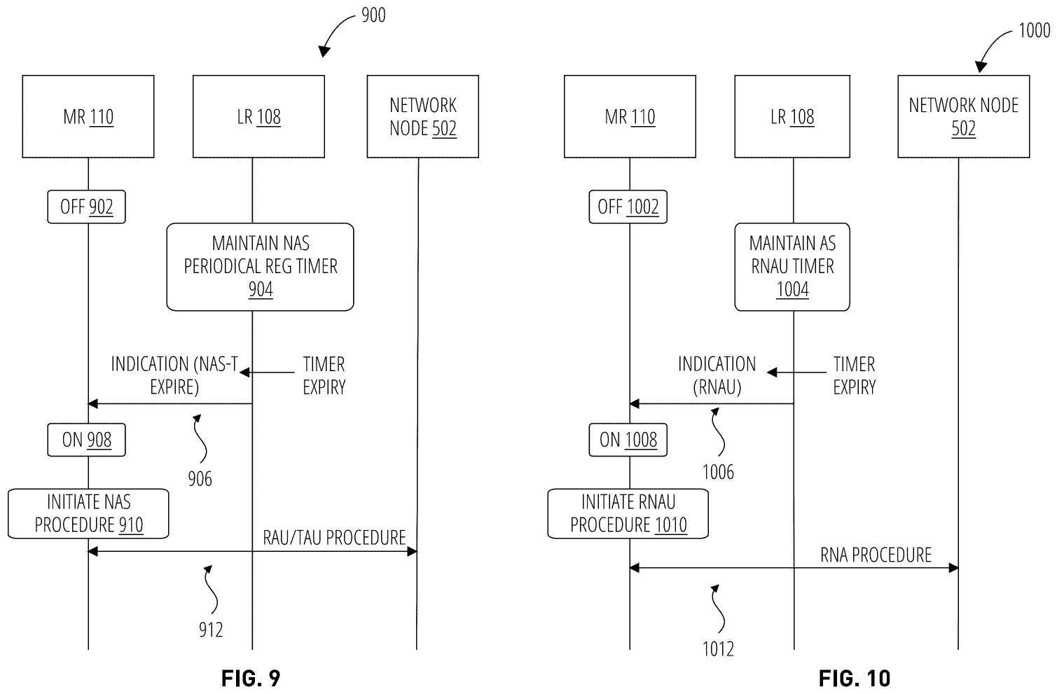

FIG. 9 illustrates a simplified signal flow diagram 900 for turning the MR 110 on based on the LR 108 determining that a NAS periodical registration timer has expired in accordance with some embodiments. In some embodiments, the LR 108 may maintain the cellular timers and detect the timer's expiry. For example, periodical cellular timers may run on the LR 108. When the timer expires, LR 108 may provide an indication (e.g., indication 906) comprising the corresponding event to MR 110.

For instance, as shown, the MR 110 may turn OFF 902. The LR 108 maintains 904 the NAS periodical registration timer. The LR 108 may determine when the timer expires while the MR 110 is OFF. The LR 108 sends an indication 906 to the MR 110 that indicates a timer expiry event to the MR 110, and the MR 110 may turn ON 908 and trigger the registration procedure. The MR 110 may initiate 910 the NAS procedure and perform the Routing Area Update/Tracking Area Update (RAU/TAU) procedure 912 with the network node 502.

FIG. 10 illustrates a simplified signal flow diagram 1000 for turning the MR 110 on based on the LR 108 determining that an AS RNAU timer has expired in accordance with some embodiments. When the UE is in an INACTIVE state, the LR 108 may maintain the RNAU timer and when the timer expires and the MR 110 is OFF, the LR 108 may indicate the RNAU timer expiry to the MR 110, causing the MR 110 to turn on and trigger the RNAU RNA procedure 1012.

For instance, as shown, the MR 110 may turn OFF 1002. The LR 108 maintains 1004 the AS RNAU timer. The LR 108 may determine when the timer expires while the MR 110 is OFF. The LR 108 may send an indication 1006 to the MR 110 that indicates a timer expiry event to the MR 110, and the MR 110 may turn ON 1008 and trigger the RNAU procedure. The MR 110 may initiate 1010 the RNAU procedure and perform the RNA procedure 1012 with the network node 502.

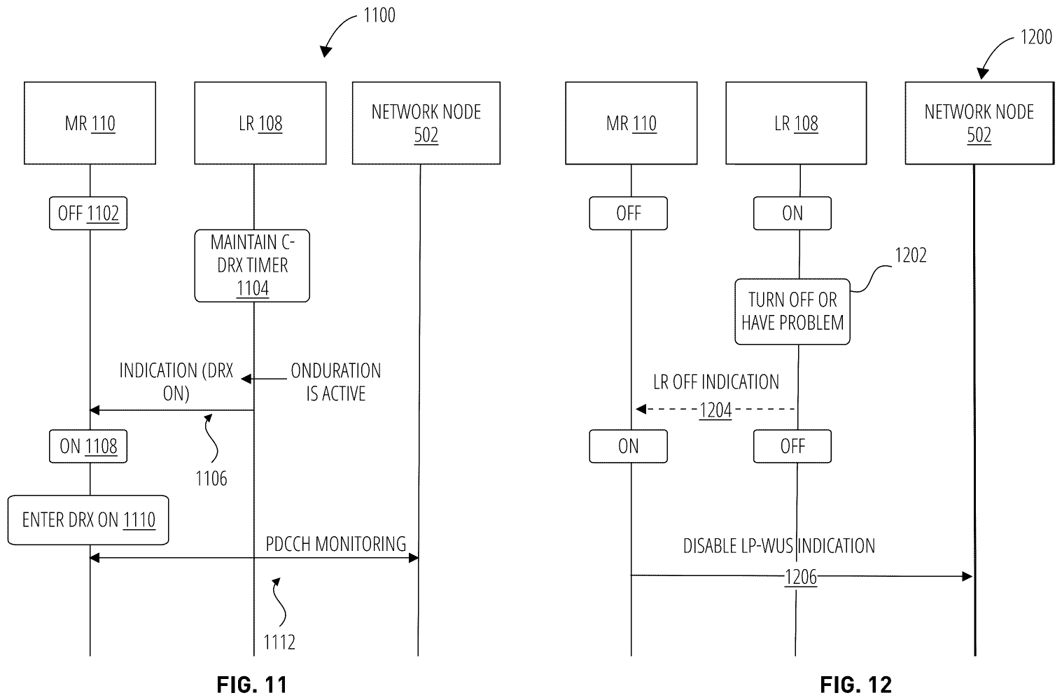

FIG. 11 illustrates a simplified signal flow diagram 1100 for turning the MR 110 on based on the LR 108 determining that DRX on duration timer has expired in accordance with some embodiments. When the UE is in an ACTIVE state, the LR 108 may maintain the DRX on duration timer (C-DRX), and when the on duration timer is about to start and the MR 110 is OFF, the LR 108 may indicate an on duration timer start event to the MR 110, and the MR 110 may turn on and enter a DRX ON state.

For instance, as shown, the MR 110 may turn OFF 1102. The LR 108 may maintain 1104 the C-DRX timer. The LR 108 may determine when the timer is about to start while the MR 110 is OFF. The LR 108 may send an indication 1106 to the MR 110 that indicates a timer start event to the MR 110, and the MR 110 may turn ON 1108 and enter 1110 DRX on state to perform PDCCH monitoring 1112.

FIG. 12 illustrates a simplified signal flow diagram 1200 for turning the MR 110 on based on a status of the LR 108. As shown, there may be other events which require the MR 110 to turn on to work. For example, when LR 108 has some problem, is not work well, or needs turn off 1202, LR 108 may inform the MR 110 using a LR off indication 1204. The LR off indication 1204 may inform the MR 110 that the LR 108 is turning off and cause the MR 110 to turn on. The MR 110 may inform the network node 502, via a disable LP-WUS indication 1206, that the LR 108 is off and cause the network node 502 to disable the LP-WUS function.

In some instances, the LR 108 may be down before informing the MR 110. Accordingly, in some embodiments, the MR 110 can detect LR failure by itself. Further, the MR 110, based on the failure detection, can turn on to enter normal work state, and inform the network node 502 to disable the LP-WUS mode.

In some embodiments, when the UE is in IDLE/INACTIVE state, the UE can suspend the indication transmission (e.g., disable LP-WUS indication 1206) until the UE resume/setup the RRC Connection due to other events.

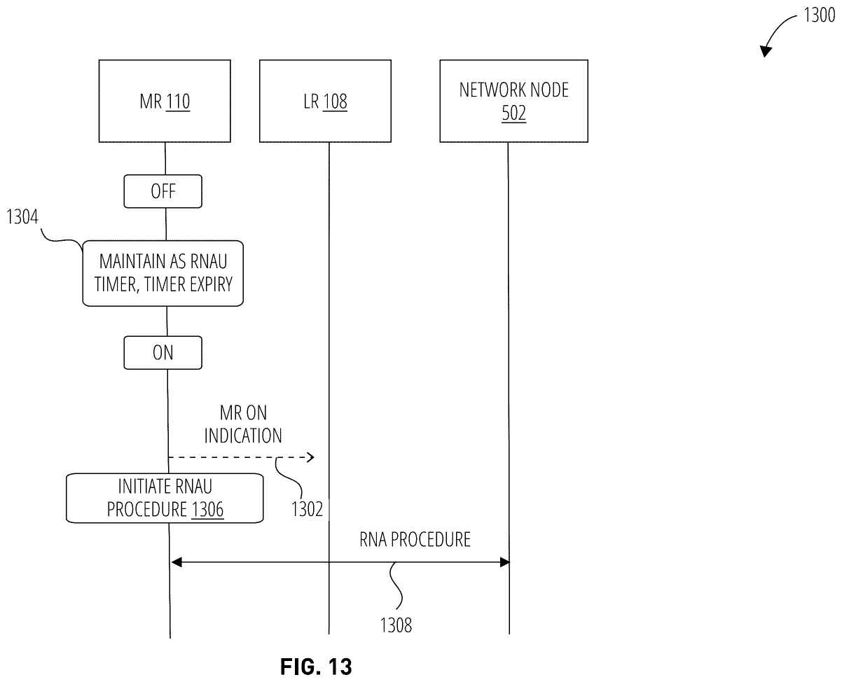

FIGS. 13-15 illustrate example signal flow diagrams for using ON-Model 2. ON-Model 2 may turn the MR on based on an LR indication and MR internal triggers. Any or all of the embodiments described with reference to FIGS. 13-15 may be combined. As shown in these figures embodiments may turn on the MR based on an external trigger from the LR or an internal trigger. The internal trigger may be based on timers. In some embodiments, the timers may be maintained on the MR.

For example, FIG. 13 illustrates a simplified signal flow diagram 1300 for turning the MR 110 on based on an internal trigger in the MR 110. In the illustrated embodiment, the MR 110 internal trigger is based on the RNAU timer that the MR 110 maintains 1304. Additionally, other timers (e.g., the NAS periodical registration timer and the C-DRX timer) may be maintained by the MR 110. The MR 110 does not fully turns off, but still maintains some periodical cellular timers, and functions such as periodical timer which may trigger UE NAS/AS procedure, or trigger UE enters DRX ON state.

When the UE is in an INACTIVE state, the MR 110 may maintain the RNAU timer and when the timer expires and the MR 110 is OFF, the MR 110 may turn on. The MR 110 may send an indication 1302 to the LR 108 that indicates that the MR 110 is on. Based on internal trigger, the MR 110 wakes up and initiates the procedure associated with the timer. In the illustrated embodiment, the MR 110 initiates 1306 the RNAU procedure and perform the RNA procedure 1308 with the network node 502.

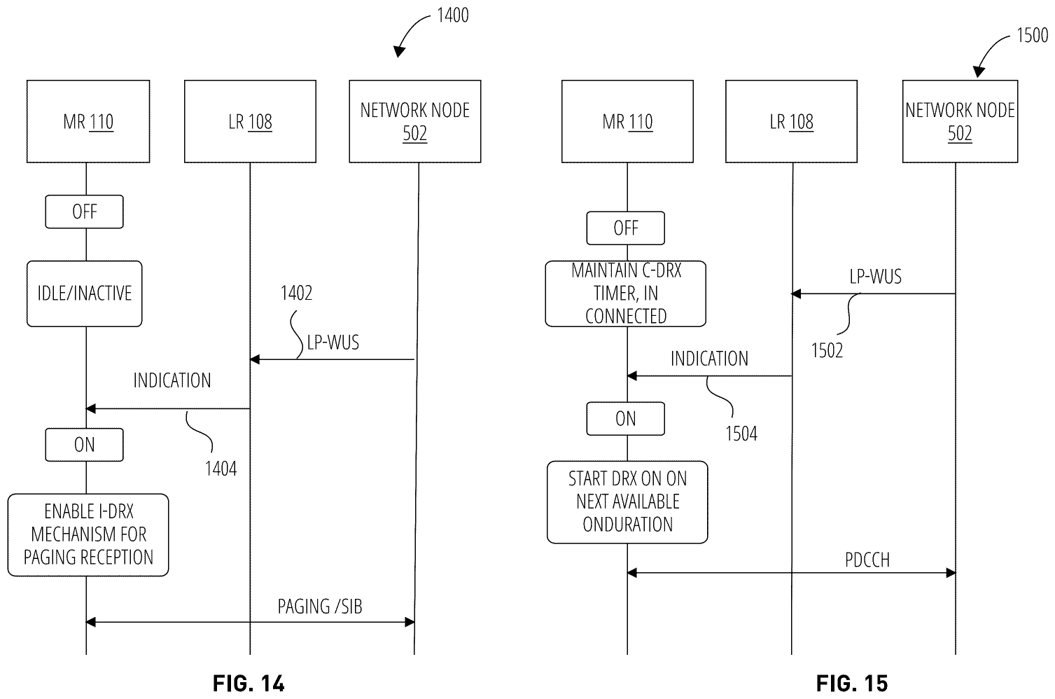

FIG. 14 illustrates a simplified signal flow diagram 1400 of an MR 110 turning on based on an external trigger from LR 108 when the UE is in an IDLE/INACTIVE state in accordance with some embodiments. As shown the MR 110 may be off and in an IDLE/INACTIVE state when the LR 108 receives a LP-WUS 1402 from the network node 502. The LP-WUS 1402 indicates that the UE should wake up. The LR 108 sends an indication 1404 to the MR 110. The indication 1404 may inform the MR 110 that the LP-WUS 1402 was received.

Based on the external trigger from LR 108, the MR 110 may consider the indication together with its current RRC state or other context to decide the UE actions in Uu interface. As shown, in RRC_IDLE/INACTIVE state, the MR 110 may turn on and enable I-DRX mechanism for paging reception. The MR 110 may receive paging/SIB from the network node 502.

FIG. 15 illustrates a simplified signal flow diagram 1500 of an MR 110 turning on based on an external trigger from LR 108 when the UE is in a CONNECTED state in accordance with some embodiments. As shown, the MR 110 may maintain the C-DRX timer.

The LR 108 may receive the LP-WUS 1502 for the UE. The LP-WUS 1502 indicates that the UE should wake up. The LR 108 sends an indication 1504 to the MR 110. The indication 1504 may inform the MR 110 that the LP-WUS 1502 was received. The MR 110 turns on and starts the operation according to the RRC state. Based on external trigger from LR 108, the MR 110 may consider the indication together with its current RRC state or other context to decide the UE actions in Uu interface. In the CONNECTED state, the MR 110 turns on and enters DRX ON state according to some specific timing, or in the next available on duration period. The MR 110 may begin PDCCH monitoring and receive UE specific data transmission from the network node 502.

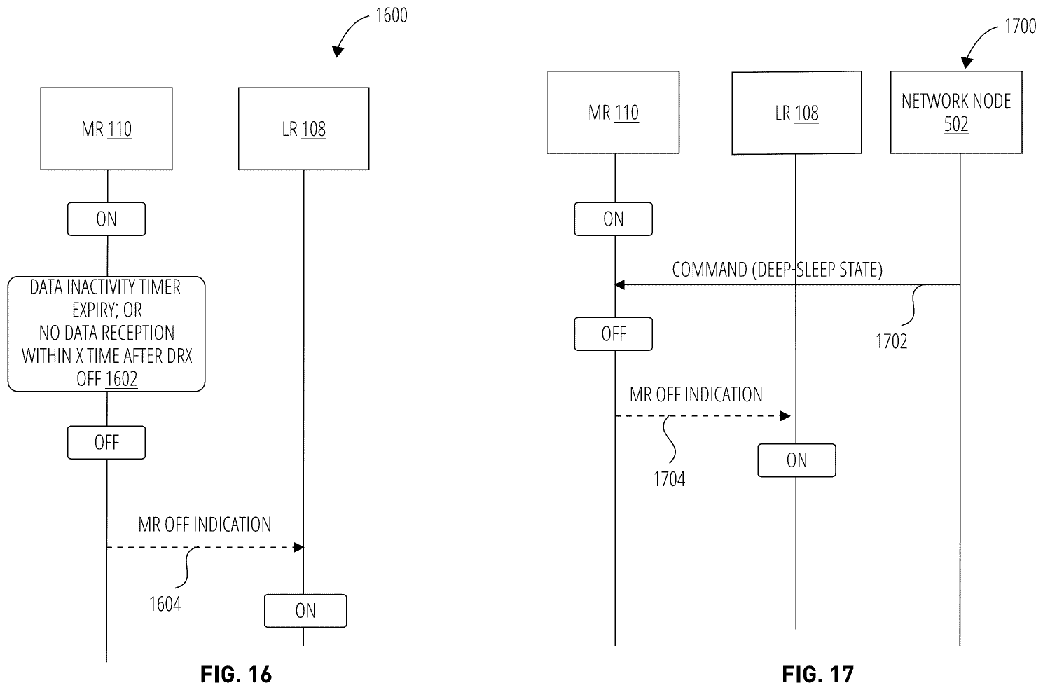

FIGS. 16-19 illustrate four events that may cause an MR to turn off. Embodiments may combine one or more of these off events and on-models described herein to turn on and off the MR. The MR may control turning itself off. For example, in some embodiments, the MR may decide to turn OFF when any one of the four events illustrated in FIGS. 16-19 occur.

FIG. 16 illustrates a simplified signal flow diagram 1600 for turning the MR 110 off based on data activity in accordance with some embodiments. A first event 1602 where the MR 110 turns off may occur when the MR 110 detects there is no activity and predicts there is no activity for some time later. The MR 110 may determine that the first event 1602 has occurred based on a timer where it detects no further data activity. For example, the MR 110 may determine that the data inactivity timer has expired or that the UE stays in DRX OFF state for some time, and turn off based on the timer expiry. The MR 110 may send an indication 1604 to the LR 108 to signal that the MR 110 is off.

FIG. 17 illustrates a simplified signal flow diagram 1700 for turning the MR 110 off based on a command from the network node 502 in accordance with some embodiments. A second event where the MR 110 turns off may occur when the MR 110 receives a network command 1702 to turn off. The network node 502 can explicitly indicate no further data transmission, or indicate that the UE is to turn off MR 110 or enter deep-sleep state. The MR 110 may send an indication 1704 to the LR 108 to signal that the MR 110 is off.

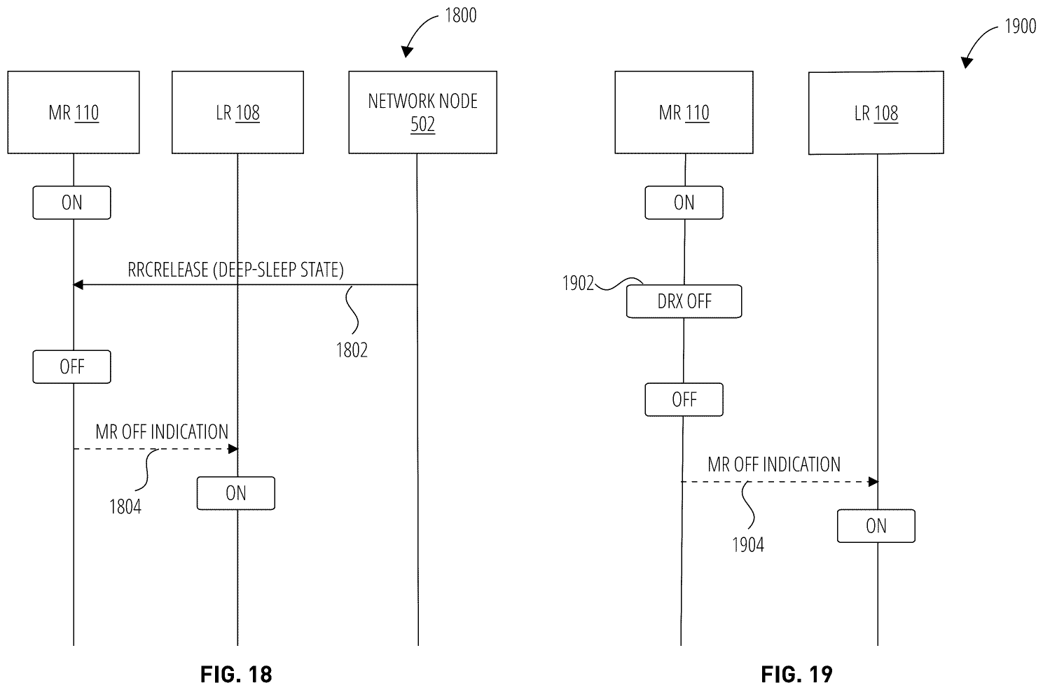

FIG. 18 illustrates a simplified signal flow diagram 1800 for turning the MR 110 off based on the UE RRC state transition in accordance with some embodiments. A third event where the MR 110 turns off may occur based on the UE RRC state transition. For example, the MR 110 may turn off when entering RRC IDLE/INACTIVE state. The MR receives a RRC release 1802 from the network node 502. The UE may turn off MR 110 when the UE enters RRC IDLE/INACTIVE state and it may be explicitly indicated by the network node 502 in RRCRelease. The MR 110 may send an indication 1804 to the LR 108 to signal that the MR 110 is off.

FIG. 19 illustrates a simplified signal flow diagram 1900 for turning the MR 110 off based on DRX OFF state in accordance with some embodiments. A fourth event 1902 where the MR 110 turns off may occur when the MR 110 detects that a CONNECTED UE enters DRX OFF state. The UE may turn off the MR 110 when it enters DRX OFF state. Turning off based on entering the DRX OFF state may be configured by a network node. The MR 110 may send an indication 1904 to the LR 108 to signal that the MR 110 is off.

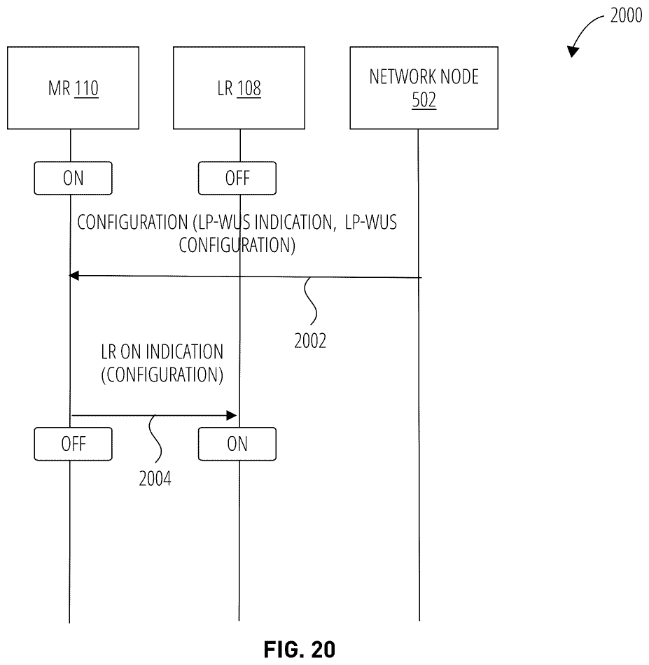

FIGS. 20-23 illustrate cases when a UE may turn the LR on and off. The embodiments shown may be combined with each other and other embodiments discussed herein. In some embodiments, the default LR state may be that the LR is off.

The LR may turn on based on MR indication. In a first case, the LR may turn on based on MR indication/configuration. For example, turning the LR on may be triggered when the MR receives the LP-WUS signal configuration or enable indication. When the MR receives such a trigger, the MR may inform the LR to turn on. The MR may provide the LP-WUS configuration to the LR for the UE's LP-WUS detection, and provides the events/timers that LR needs to be maintained. In a second case, the LR may turn on based on MR status.

In some embodiments, the LR may turn off when it receives an off indication from the MR. The MR may inform LR to turn OFF in the following cases. In a first case, when the UE moves to a new cell where the LP-WUS is not supported, the MR can inform the LR to turn off. In a second case, when the UE detects/predicts there is no activity in Uu interface for some time in the future, the MR can inform the LR to turn off. In a third case, when the UE receives a network indication to turn off the LR, the MR can inform the LR to turn off. In a fourth case, when there is a UE RRC state transition (e.g. entering RRC IDLE/INACTIVE), the MR can inform the LR to turn off. In a fifth case, when the UE MR initiates some special procedure (UE connection reestablishment), the MR can inform the LR to turn off. When the LR receives the off indication from the MR, the LR turns off.

In some embodiments, the LR can turn off when the LR cannot work well. For example, as shown in FIG. 12 the LR may turn off and send an indication to the MR.

FIG. 20 illustrates a simplified signal flow diagram 2000 where the LR 108 is turned on based on an MR indication/configuration in accordance with some embodiments. The MR 110 receives a trigger from the network node 502 to turn the LR 108 on. For example, in the illustrated embodiment, the MR 110 receives a message 2002 from the network node 502. The message 2002 may comprise the LP-WUS signal configuration and/or an enable indication. The MR 110 informs, via an LR on indication 2004, the LR 108 to turn on. In some embodiments, the MR 110 provide the LP-WUS configuration to the LR 108 for the UE's LP-WUS detection, and provides the events/timers that LR 108 should maintain. These configuration details may be included in the LR on indication 2004. When the LR 108 receives the LR on indication 2004, the LR 108 turns on and the MR 110 turns off.

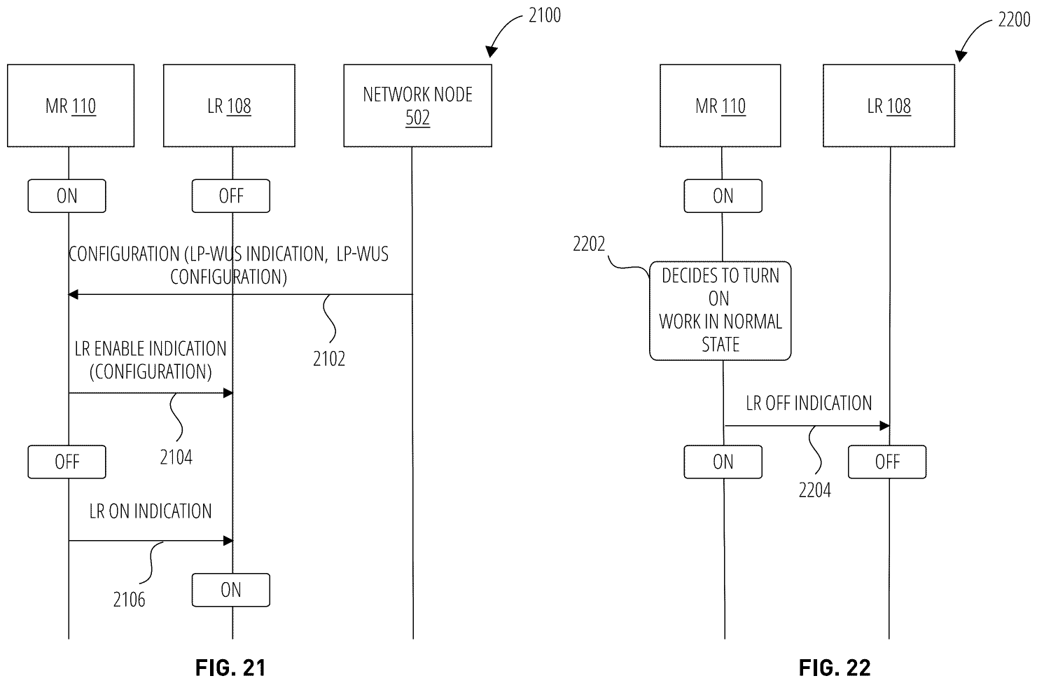

FIG. 21 illustrates a simplified signal flow diagram 2100 where the LR 108 is turned on based on MR status in accordance with some embodiments. The MR 110 receives a configuration 2102 from the network node 502 for LP-WUS. The configuration 2102 may comprise the LP-WUS signal configuration and/or an enable indication. The MR 110 may send an LR enable indication 2104 to the LR 108. The LR enable indication 2104 may include the LP-WUS configuration to the LR 108 for the UE's LP-WUS detection including the events/timers that LR 108 should maintain.

When the MR 110 turns off, the MR 110 will be inform LR to turn ON. For example, the MR 2106 may send an on indication 2106 t0 the LR 108. When the LR 108 receives the on indication 2106, the LR 108 turns on and the MR 110 turns off.

FIG. 22 illustrates a signal flow diagram 2200 for turning off the LR 108 based on an indication from the MR 110 in accordance with some embodiments. As shown, the MR 110 turns on and decides 2202 to turn on work in a normal state. The MR 110 may send an LR off indication 2204 to the LR 108 causing the LR 108 to turn off.

The MR 110 may inform the LR 108 to turn off in the following cases. In a first case, when the UE moves to a new cell where the LP-WUS is not supported, the MR 110 can inform the LR 108 to turn off. In a second case, when the UE detects/predicts there is no activity in Uu interface for some time in the future, the MR 110 can inform the LR 108 to turn off. In a third case, when the UE receives a network indication to turn off the LR 108, the MR 110 can inform the LR 108 to turn off. In a fourth case, when there is a UE RRC state transition (e.g. entering RRC IDLE/INACTIVE), the MR 110 can inform the LR 108 to turn off. In a fifth case, when the UE MR 110 initiates some special procedure (UE connection reestablishment), the MR 110 can inform the LR 108 to turn off. When the LR 108 receives the off indication from the MR 110, the LR 108 turns off.

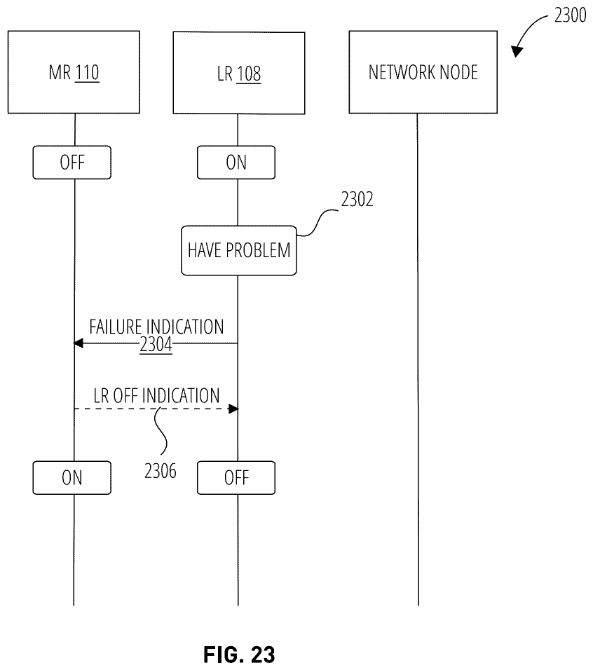

FIG. 23 illustrates a signal flow diagram 2300 for turning off the LR 108 when the LR 108 cannot work well. As shown, the LR 108 may be on and the MR 110 may be off. The LR 108 may have a problem 2302 and need to turn off. The LR 108 may send a failure indication 2304 to the MR 110. In some embodiments, the MR 110 may send an LR off indication 2306 to the LR 108. The MR 110 may turn on, and the LR 108 may turn off.

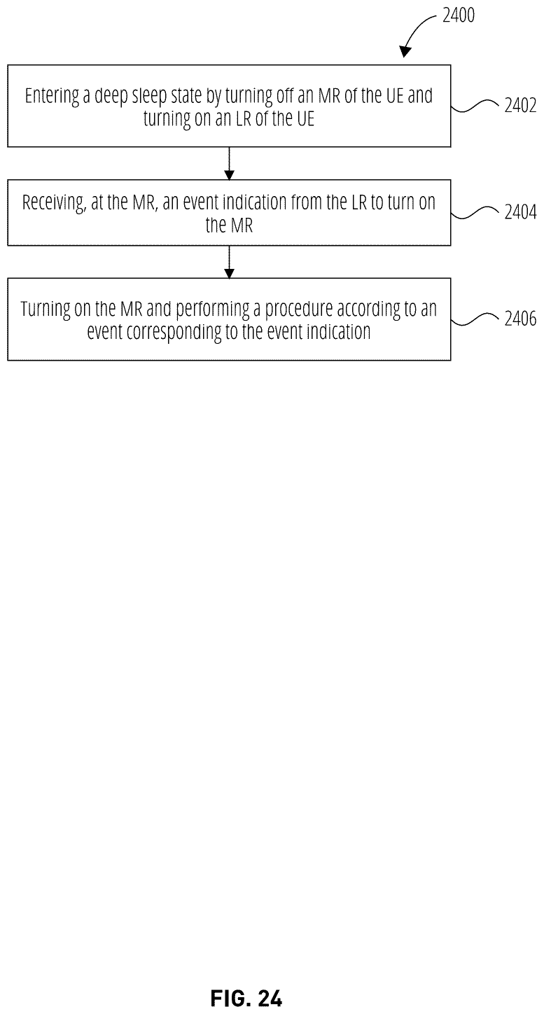

FIG. 24 illustrates a flowchart of a method 2400 for a UE, according to embodiments herein. The method 2400 includes entering 2402 a deep sleep state by turning off an MR of the UE and turning on an LR of the UE.

The method 2400 further includes receiving 2404, at the MR, an event indication from the LR to turn on the MR.

The method 2400 further includes turning 2406 on the MR and performing a procedure according to an event corresponding to the event indication.

In some embodiments, the method 2400 further comprises receiving, at the LR, a low power wake up signal from a network node, wherein the LR sends the event indication to the MR when the low power wake up signal is received.

In some embodiments, the method 2400 further comprises measuring, via the LR, radio quality of a low power wake up signal from a network node, wherein the LR sends the event indication to the MR when the radio quality is less than a threshold.

In some embodiments, the method 2400 further comprises maintaining, via the LR, one or more periodical cellular timers, wherein the LR sends the event indication to the MR when any of the one or more periodical cellular timers expire.

In some embodiments, the method 2400 further comprises determining, via the LR, that a failure of the LR has occurred, wherein the LR sends the event indication to the MR when the failure occurs and sending, via the MR, a disable low power wake up signal indication to a network node.

In some embodiments of the method 2400, in the deep sleep state, the MR maintains one or more periodical cellular timers.

In some embodiments of the method 2400, the MR is turned off when the MR detects there is no the activity and predict there is no activity for some time later.

In some embodiments of the method 2400, the MR is turned off when the MR receives a network command to turn off.

In some embodiments of the method 2400, the MR is turned off based on a UE RRC state transition.

In some embodiments, the method 2400 further comprises sending, via the MR, a LR on indication to the LR to cause the LR to turn on.

In some embodiments, the method 2400 further comprises sending, via the MR, a LR off indication to the LR to cause the LR to turn off.

Embodiments contemplated herein include an apparatus comprising means to perform one or more elements of the method 2400. This apparatus may be, for example, an apparatus of a UE (such as a wireless device 2602 that is a UE, as described herein).

Embodiments contemplated herein include one or more non-transitory computer-readable media comprising instructions to cause an electronic device, upon execution of the instructions by one or more processors of the electronic device, to perform one or more elements of the method 2400. This non-transitory computer-readable media may be, for example, a memory of a UE (such as a memory of a wireless device 2602 that is a UE, as described herein).

Embodiments contemplated herein include an apparatus comprising logic, modules, or circuitry to perform one or more elements of the method 2400. This apparatus may be, for example, an apparatus of a UE (such as a wireless device 2602 that is a UE, as described herein).

Embodiments contemplated herein include an apparatus comprising: one or more processors and one or more computer-readable media comprising instructions that, when executed by the one or more processors, cause the one or more processors to perform one or more elements of the method 2400. This apparatus may be, for example, an apparatus of a UE (such as a wireless device 2602 that is a UE, as described herein).

Embodiments contemplated herein include a signal as described in or related to one or more elements of the method 2400.

Embodiments contemplated herein include a computer program or computer program product comprising instructions, wherein execution of the program by a processor is to cause the processor to carry out one or more elements of the method 2400. The processor may be a processor of a UE (such as a processor(s) 2604 of a wireless device 2602 that is a UE, as described herein). These instructions may be, for example, located in the processor and/or on a memory of the UE (such as a memory of a wireless device 2602 that is a UE, as described herein).

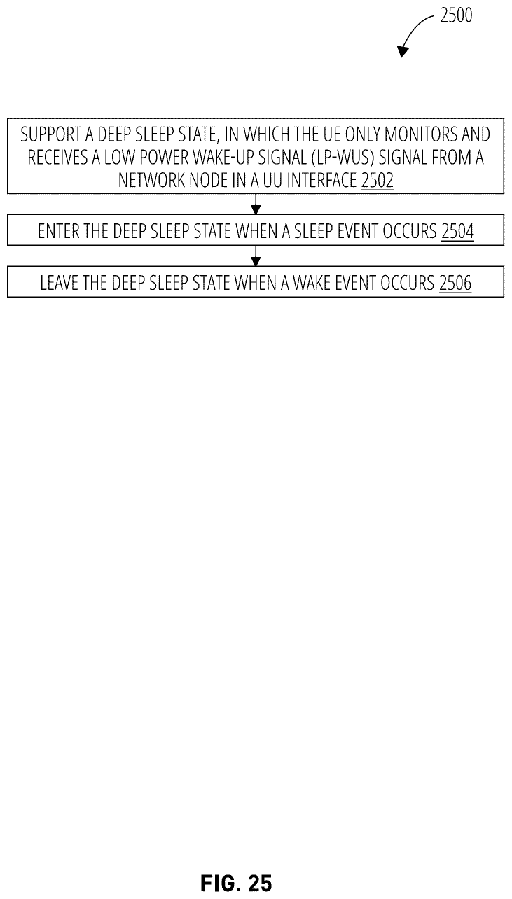

FIG. 25 illustrates a flowchart of a method 2500 for a UE, according to embodiments herein. The method 2500 includes supporting 2502 a deep sleep state, in which the UE only monitors and receives a low power wake-up signal (LP-WUS) signal from a network node in a Uu interface. The method 2500 further includes entering 2504 the deep sleep state when a sleep event occurs. The method 2500 further includes leaving 2506 the deep sleep state when a wake event occurs.

In some embodiments of the method 2500, the wake event comprises receiving the LP-WUS from the network node, wherein the low power wake up signal is sent to the UE or to a UE group to which the UE belongs.

In some embodiments, the method 2500 further comprises, measuring radio quality of the LP-WUS from the network node, wherein the wake event comprises measuring that the radio quality of the LP-WUS is less than a threshold.

In some embodiments, the method 2500 further comprises maintaining, one or more periodical cellular timers, wherein the wake event comprises determining that any of the one or more periodical cellular timers has expired.

In some embodiments, the method 2500 further comprises determining a failure of a LP-WUS signaling reception function has occurred, wherein the wake event comprises the failure of the LP-WUS signaling reception function.

In some embodiments of the method 2500, determining the failure of the LP-WUS signaling function further comprises sending a low power wake up signal failure and deactivation indication to the network node.

In some embodiments of the method 2500, when in the deep sleep state, the UE maintains one or more periodical cellular timers.

In some embodiments of the method 2500, the sleep event occurs when there is no the activity and predicts there is no activity until later.

In some embodiments of the method 2500, the sleep event comprises receiving a network command to enter the deep sleep state.

In some embodiments of the method 2500, the sleep event comprises a UE Radio Resource Control (RRC) state transition.

In some embodiments of the method 2500, entering the deep sleep state comprises enabling and activating a LP-WUS monitoring and reception function.

In some embodiments of the method 2500, the wake event comprises receiving a configuration or indication to deactivate and disable the LP-WUS monitoring and reception function.

Embodiments contemplated herein include an apparatus comprising means to perform one or more elements of the method 2500. This apparatus may be, for example, an apparatus of a UE (such as a wireless device 2702 that is a UE, as described herein).

Embodiments contemplated herein include one or more non-transitory computer-readable media comprising instructions to cause an electronic device, upon execution of the instructions by one or more processors of the electronic device, to perform one or more elements of the method 2500. This non-transitory computer-readable media may be, for example, a memory of a UE (such as a memory 2706 of a wireless device 2702 that is a UE, as described herein).

Embodiments contemplated herein include an apparatus comprising logic, modules, or circuitry to perform one or more elements of the method 2500. This apparatus may be, for example, an apparatus of a UE (such as a wireless device 2702 that is a UE, as described herein).

Embodiments contemplated herein include an apparatus comprising: one or more processors and one or more computer-readable media comprising instructions that, when executed by the one or more processors, cause the one or more processors to perform one or more elements of the method 2500. This apparatus may be, for example, an apparatus of a UE (such as a wireless device 2702 that is a UE, as described herein).

Embodiments contemplated herein include a signal as described in or related to one or more elements of the method 2500.

Embodiments contemplated herein include a computer program or computer program product comprising instructions, wherein execution of the program by a processor is to cause the processor to carry out one or more elements of the method 2500. The processor may be a processor of a UE (such as a processor(s) 2704 of a wireless device 2702 that is a UE, as described herein). These instructions may be, for example, located in the processor and/or on a memory of the UE (such as a memory 2706 of a wireless device 2702 that is a UE, as described herein).

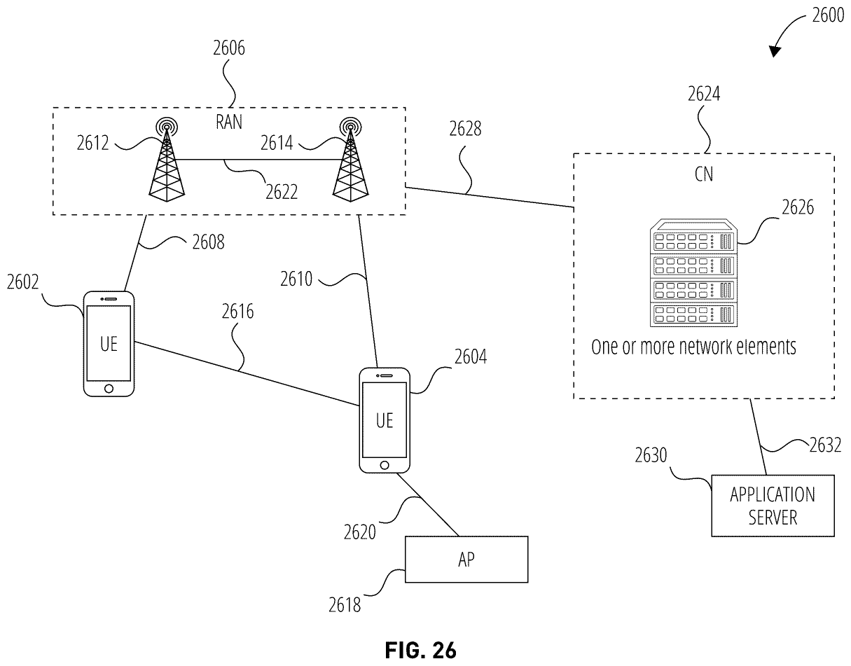

FIG. 26 illustrates an example architecture of a wireless communication system 2600, according to embodiments disclosed herein. The following description is provided for an example wireless communication system 2600 that operates in conjunction with the LTE system standards and/or 5G or NR system standards as provided by 3GPP technical specifications.

As shown by FIG. 26, the wireless communication system 2600 includes UE 2602 and UE 2604 (although any number of UEs may be used). In this example, the UE 2602 and the UE 2604 are illustrated as smartphones (e.g., handheld touchscreen mobile computing devices connectable to one or more cellular networks), but may also comprise any mobile or non-mobile computing device configured for wireless communication.

The UE 2602 and UE 2604 may be configured to communicatively couple with a RAN 2606. In embodiments, the RAN 2606 may be NG-RAN, E-UTRAN, etc. The UE 2602 and UE 2604 utilize connections (or channels) (shown as connection 2608 and connection 2610, respectively) with the RAN 2606, each of which comprises a physical communications interface. The RAN 2606 can include one or more base stations (such as base station 2612 and base station 2614) that enable the connection 2608 and connection 2610.

In this example, the connection 2608 and connection 2610 are air interfaces to enable such communicative coupling, and may be consistent with RAT(s) used by the RAN 2606, such as, for example, an LTE and/or NR.

In some embodiments, the UE 2602 and UE 2604 may also directly exchange communication data via a sidelink interface 2616. The UE 2604 is shown to be configured to access an access point (shown as AP 2618) via connection 2620. By way of example, the connection 2620 can comprise a local wireless connection, such as a connection consistent with any IEEE 802.11 protocol, wherein the AP 2618 may comprise a Wi-Fi® router. In this example, the AP 2618 may be connected to another network (for example, the Internet) without going through a CN 2624.

In embodiments, the UE 2602 and UE 2604 can be configured to communicate using orthogonal frequency division multiplexing (OFDM) communication signals with each other or with the base station 2612 and/or the base station 2614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 2612 or base station 2614 may be implemented as one or more software entities running on server computers as part of a virtual network. In addition, or in other embodiments, the base station 2612 or base station 2614 may be configured to communicate with one another via interface 2622. In embodiments where the wireless communication system 2600 is an LTE system (e.g., when the CN 2624 is an EPC), the interface 2622 may be an X2 interface. The X2 interface may be defined between two or more base stations (e.g., two or more eNBs and the like) that connect to an EPC, and/or between two eNBs connecting to the EPC. In embodiments where the wireless communication system 2600 is an NR system (e.g., when CN 2624 is a 5GC), the interface 2622 may be an Xn interface. The Xn interface is defined between two or more base stations (e.g., two or more gNBs and the like) that connect to 5GC, between a base station 2612 (e.g., a gNB) connecting to 5GC and an CNB, and/or between two eNBs connecting to 5GC (e.g., CN 2624).

The RAN 2606 is shown to be communicatively coupled to the CN 2624. The CN 2624 may comprise one or more network elements 2626, which are configured to offer various data and telecommunications services to customers/subscribers (e.g., users of UE 2602 and UE 2604) who are connected to the CN 2624 via the RAN 2606. The components of the CN 2624 may be implemented in one physical device or separate physical devices including components to read and execute instructions from a machine-readable or computer-readable medium (e.g., a non-transitory machine-readable storage medium).

In embodiments, the CN 2624 may be an EPC, and the RAN 2606 may be connected with the CN 2624 via an S1 interface 2628. In embodiments, the S1 interface 2628 may be split into two parts, an S1 user plane (S1-U) interface, which carries traffic data between the base station 2612 or base station 2614 and a serving gateway (S-GW), and the S1-MME interface, which is a signaling interface between the base station 2612 or base station 2614 and mobility management entities (MMEs).

In embodiments, the CN 2624 may be a 5GC, and the RAN 2606 may be connected with the CN 2624 via an NG interface 2628. In embodiments, the NG interface 2628 may be split into two parts, an NG user plane (NG-U) interface, which carries traffic data between the base station 2612 or base station 2614 and a user plane function (UPF), and the S1 control plane (NG-C) interface, which is a signaling interface between the base station 2612 or base station 2614 and access and mobility management functions (AMFs).

Generally, an application server 2630 may be an element offering applications that use internet protocol (IP) bearer resources with the CN 2624 (e.g., packet switched data services). The application server 2630 can also be configured to support one or more communication services (e.g., VOIP sessions, group communication sessions, etc.) for the UE 2602 and UE 2604 via the CN 2624. The application server 2630 may communicate with the CN 2624 through an IP communications interface 2632.

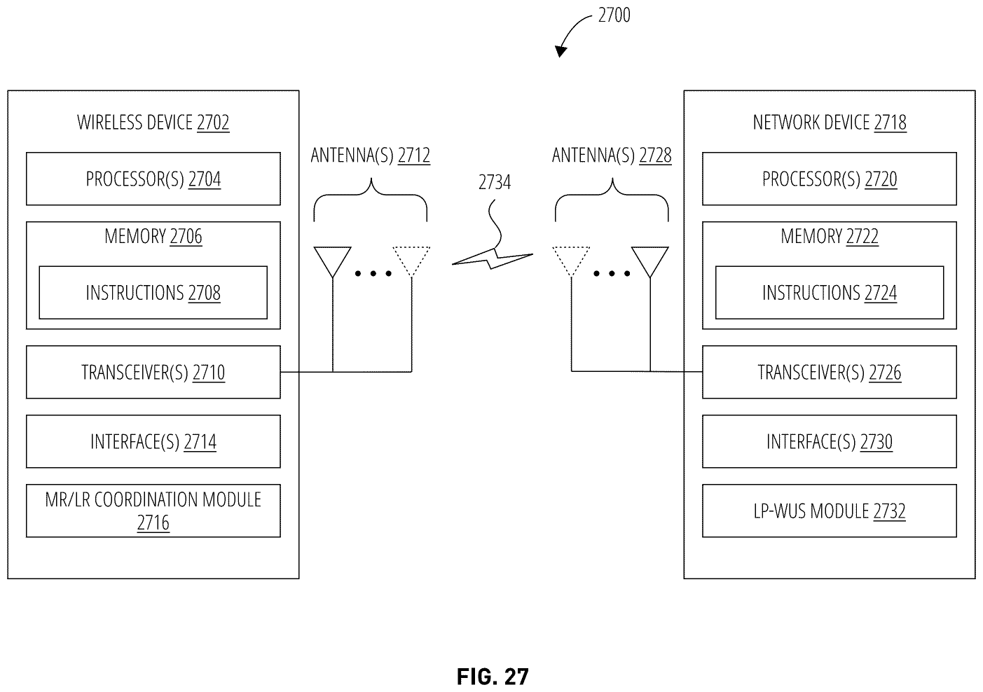

FIG. 27 illustrates a system 2700 for performing signaling 2734 between a wireless device 2702 and a network device 2718, according to embodiments disclosed herein. The system 2700 may be a portion of a wireless communications system as herein described. The wireless device 2702 may be, for example, a UE of a wireless communication system. The network device 2718 may be, for example, a base station (e.g., an eNB or a gNB) of a wireless communication system.

The wireless device 2702 may include one or more processor(s) 2704. The processor(s) 2704 may execute instructions such that various operations of the wireless device 2702 are performed, as described herein. The processor(s) 2704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 2702 may include a memory 2706. The memory 2706 may be a non-transitory computer-readable storage medium that stores instructions 2708 (which may include, for example, the instructions being executed by the processor(s) 2704). The instructions 2708 may also be referred to as program code or a computer program. The memory 2706 may also store data used by, and results computed by, the processor(s) 2704.

The wireless device 2702 may include one or more transceiver(s) 2710 that may include radio frequency (RF) transmitter circuitry and/or receiver circuitry that use the antenna(s) 2712 of the wireless device 2702 to facilitate signaling (e.g., the signaling 2734) to and/or from the wireless device 2702 with other devices (e.g., the network device 2718) according to corresponding RATs.

The wireless device 2702 may include one or more antenna(s) 2712 (e.g., one, two, four, or more). For embodiments with multiple antenna(s) 2712, the wireless device 2702 may leverage the spatial diversity of such multiple antenna(s) 2712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 2702 may be accomplished according to precoding (or digital beamforming) that is applied at the wireless device 2702 that multiplexes the data streams across the antenna(s) 2712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 2702 may implement analog beamforming techniques, whereby phases of the signals sent by the antenna(s) 2712 are relatively adjusted such that the (joint) transmission of the antenna(s) 2712 can be directed (this is sometimes referred to as beam steering).

The wireless device 2702 may include one or more interface(s) 2714. The interface(s) 2714 may be used to provide input to or output from the wireless device 2702. For example, a wireless device 2702 that is a UE may include interface(s) 2714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 2710/antenna(s) 2712 already described) that allow for communication between the UE and other devices and may operate according to known protocols (e.g., Wi-Fi®, Bluetooth®, and the like).

The wireless device 2702 may include an MR/LR coordination module 2716. The MR/LR coordination module 2716 may be implemented via hardware, software, or combinations thereof. For example, the MR/LR coordination module 2716 may be implemented as a processor, circuit, and/or instructions 2708 stored in the memory 2706 and executed by the processor(s) 2704. In some examples, the MR/LR coordination module 2716 may be integrated within the processor(s) 2704 and/or the transceiver(s) 2710. For example, the MR/LR coordination module 2716 may be implemented by a combination of software components (e.g., executed by a DSP or a general processor) and hardware components (e.g., logic gates and circuitry) within the processor(s) 2704 or the transceiver(s) 2710.

The MR/LR coordination module 2716 may be used for various aspects of the present disclosure, for example, aspects of FIGS. 1-24. The MR/LR coordination module 2716 is configured to turn on and off the MR and LR.

The network device 2718 may include one or more processor(s) 2720. The processor(s) 2720 may execute instructions such that various operations of the network device 2718 are performed, as described herein. The processor(s) 2720 may include one or more baseband processors implemented using, for example, a CPU, a DSP, an ASIC, a controller, an FPGA device, another hardware device, a firmware device, or any combination thereof configured to perform the operations described herein.

The network device 2718 may include a memory 2722. The memory 2722 may be a non-transitory computer-readable storage medium that stores instructions 2724 (which may include, for example, the instructions being executed by the processor(s) 2720). The instructions 2724 may also be referred to as program code or a computer program. The memory 2722 may also store data used by, and results computed by, the processor(s) 2720.

The network device 2718 may include one or more transceiver(s) 2726 that may include RF transmitter circuitry and/or receiver circuitry that use the antenna(s) 2728 of the network device 2718 to facilitate signaling (e.g., the signaling 2734) to and/or from the network device 2718 with other devices (e.g., the wireless device 2702) according to corresponding RATs.

The network device 2718 may include one or more antenna(s) 2728 (e.g., one, two, four, or more). In embodiments having multiple antenna(s) 2728, the network device 2718 may perform MIMO, digital beamforming, analog beamforming, beam steering, etc., as has been described.

The network device 2718 may include one or more interface(s) 2730. The interface(s) 2730 may be used to provide input to or output from the network device 2718. For example, a network device 2718 that is a base station may include interface(s) 2730 made up of transmitters, receivers, and other circuitry (e.g., other than the transceiver(s) 2726/antenna(s) 2728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 2718 may include an LP-WUS module 2732. The LP-WUS module 2732 may be implemented via hardware, software, or combinations thereof. For example, the LP-WUS module 2732 may be implemented as a processor, circuit, and/or instructions 2724 stored in the memory 2722 and executed by the processor(s) 2720. In some examples, the LP-WUS module 2732 may be integrated within the processor(s) 2720 and/or the transceiver(s) 2726. For example, the LP-WUS module 2732 may be implemented by a combination of software components (e.g., executed by a DSP or a general processor) and hardware components (e.g., logic gates and circuitry) within the processor(s) 2720 or the transceiver(s) 2726.

The LP-WUS module 2732 may be used for various aspects of the present disclosure, for example, aspects of FIGS. 1-24. The LP-WUS module 2732 is configured to send LP-WUS signals, LP-WUS configurations, and other commands.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
supporting a deep sleep state, in which the UE only monitors and receives a low power wake-up signal (LP-WUS) from a network node in a Uu interface;
entering the deep sleep state when a sleep event occurs; and
leaving the deep sleep state when a wake event occurs.

2. The method of claim 1, wherein the wake event comprises receiving the LP-WUS from the network node, wherein the low power wake up signal is sent to the UE or to a UE group to which the UE belongs.

3. The method of claim 1, further comprising, measuring radio quality of the LP-WUS from the network node,
wherein the wake event comprises measuring that the radio quality of the LP-WUS is less than a threshold.

4. The method of claim 1, further comprising, maintaining, one or more periodical cellular timers,
wherein the wake event comprises determining that any of the one or more periodical cellular timers has expired.

5. The method of claim 1, further comprising, determining a failure of a LP-WUS signaling reception function has occurred,
wherein the wake event comprises the failure of the LP-WUS signaling reception function.

6. The method of claim 5, wherein determining the failure of the LP-WUS signaling reception function further comprises:
sending a low power wake up signal failure and deactivation indication to the network node.

7. The method of claim 1, wherein when in the deep sleep state, the UE maintains one or more periodical cellular timers.

8. The method of claim 1, wherein the sleep event occurs when there is no the activity and predicts there is no activity until later.

9. The method of claim 1, wherein the sleep event comprises receiving a network command to enter the deep sleep state.

10. The method of claim 1, wherein the sleep event comprises a UE Radio Resource Control (RRC) state transition.

11. The method of claim 1, wherein entering the deep sleep state comprises enabling and activating a LP-WUS monitoring and reception function.

12. The method of claim 11, wherein the wake event comprises receiving a configuration or indication to deactivate and disable the LP-WUS monitoring and reception function.

13. A user equipment (UE) apparatus comprising:
a processor; and
a memory storing instructions that, when executed by the processor, configure the apparatus to:
support a deep sleep state, in which the UE only monitors and receives a low power wake-up signal (LP-WUS) from a network node in a Uu interface;
enter the deep sleep state when a sleep event occurs; and
leave the deep sleep state when a wake event occurs.

14. The UE apparatus of claim 13, wherein the wake event comprises receiving the LP-WUS from the network node, wherein the low power wake up signal is sent to the UE or to a UE group to which the UE belongs.

15. The UE apparatus of claim 13, wherein the instructions further configure the apparatus to, measure radio quality of the LP-WUS from the network node,
wherein the wake event comprises measuring that the radio quality of the LP-WUS is less than a threshold.

16. The UE apparatus of claim 13, wherein the instructions further configure the apparatus to, maintain, one or more periodical cellular timers,
wherein the wake event comprises determining that any of the one or more periodical cellular timers has expired.

17. A non-transitory computer-readable storage medium, the computer-readable storage medium including instructions that when executed by a user equipment (UE), cause the UE to:
support a deep sleep state, in which the UE only monitors and receives a low power wake-up signal (LP-WUS) from a network node in a Uu interface;
enter the deep sleep state when a sleep event occurs; and
leave the deep sleep state when a wake event occurs.

18. The computer-readable storage medium of claim 17, wherein the instructions further configure the UE to, determine a failure of a LP-WUS signaling reception function has occurred,
wherein the wake event comprises the failure of the LP-WUS signaling reception function.

19. The computer-readable storage medium of claim 18, wherein determining the failure of the LP-WUS signaling reception function further comprises:
send a low power wake up signal failure and deactivation indication to the network node.

20. The computer-readable storage medium of claim 17, wherein when in the deep sleep state, the UE maintains one or more periodical cellular timers.
